(19) United States
(12) Patent Application Publication
(10) Pub. No.: US 2025/0332550 A1
(43) Pub. Date: Oct. 30, 2025

(54) DIRECT COATING OF ANION EXCHANGE MEMBRANES WITH CATALYTICALLY ACTIVE MATERIAL

(71) Applicant: Evonik Operations GmbH, Essen (DE)

(72) Inventors: Sebastian Watzele, Recklinghausen (DE); Sonja Merkulov, Marl (DE); Andreas Wild, Haltern am See (DE)

(21) Appl. No.: 19/169,391

(22) Filed: Apr. 3, 2025

(30) Foreign Application Priority Data
Apr. 29, 2024 (EP) 24172943.3

(51) Int. Cl. B01D 67/00; B01D 71/52; B01D 71/68

(52) U.S. Cl. CPC B01D 67/0088; B01D 67/0095; B01D 71/5221; B01D 71/68; B01D 2323/219; B01D 2325/10; B01D 2325/42

(57) ABSTRACT

The invention relates to the coating of anion exchange membranes (AEM) with catalytically active substances. The CCM thus obtained are used in electrochemical cells, especially for alkaline water electrolysis. It was an object of the invention to specify a process for producing a CCM by direct coating which maintains the necessary planarity of the AEM and ideally avoids the use of lost films and eschews CMR substances. Swelling shall also be minimized. The process shall also be performable with fluorine-free ionomers. The invention is based on the finding that the addition of certain organic substances has the result that the AEM swells only to a small extent, if at all (antiswelling agent). It has surprisingly been found that substances suitable as antiswelling agents are identifiable by their solubility behaviour, more particularly by their Hansen parameters.

The invention relates to the coating of anion exchange membranes with catalytically active material. The catalytically actively coated anion exchange membranes are used in electrochemical cells, in particular for water electrolysis.

Anion exchange membranes (AEM) are installed in electrochemical cells. They are generally used to separate reaction products from the anode and the cathode and to conduct negatively charged ions (anions) towards the anode. This makes the electrochemical reactions practiced in the cell more efficient, safer or even possible in the first place.

An example of an electrochemical process which is performed with the aid of an anion exchange membrane is the production of hydrogen and oxygen by alkaline water electrolysis. This is done by using an anion exchange membrane as a separator between the electrodes of the cell. For this reason, the process is also referred to as AEM water electrolysis (AEMWE). Since the reaction takes place in an alkaline medium, AEM water electrolysis is often also called alkaline membrane water electrolysis.

In the case of AEM-based water electrolysis an electrochemical cell is filled with water or with a basic water-based electrolyte and a voltage is applied between the anode and the cathode. On the cathode side, the water (H₂O) is broken down into hydrogen (H₂) and hydroxide ions (OH⁻) (Equation K). The anion exchange membrane transports the hydroxide ions onto the anode side, where they are oxidized to oxygen (O₂) (equation A). This forms oxygen on the anode side while hydrogen is formed on the cathode side. Consequently, the anode side is also called the oxygen side while the cathode side is also called the hydrogen side.

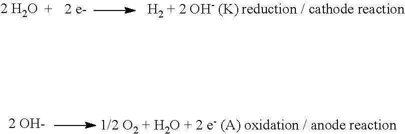

To enable the described effect the anion exchange membrane must conduct the hydroxide ions between the anode and the cathode. Apart from the ionic conductivity it must simultaneously be as electrically insulating as possible in order that there is no electrical short between the anode and the cathode. Finally, the anion exchange membrane must have a gas permeability that is as low as possible to avoid backmixing of the gases formed. Moreover, the anion exchange membrane must withstand the alkaline conditions that exist in AEM water electrolysis. These properties are satisfied by specific anion-conducting polymers (also known as: anion-conducting ionomers). Anion exchange membranes are made entirely or at least partially of such anion-conducting monomers. AEM are typically present in the form of a flat membrane.

To accelerate the reaction in the electrochemical cell, catalytically active or activatable materials (also known as electrocatalysts) are incorporated both on the cathode side and on the anode side. This is accomplished by introducing catalytically active layers into the cell or by catalytically active coatings of cell components. These may be present on a substrate material specially introduced into the cell for the purpose or on a porous transport layer (catalyst-coated substrate, CCS), or else the membrane may be directly coated with catalytically active material (catalyst-coated membrane, CCM).

An excellent overview of the construction and materials of the electrochemical cells currently in use in AEM water electrolysis is given by:
Miller, Hamish Andrew et al: Green hydrogen from anion exchange membrane water electrolysis: a review of recent developments in critical materials and operating conditions. Sustainable Energy Fuels, 2020, 4, 2114 DOI: 10.1039/c9se01240k

Once basic questions regarding the choice of materials and operating conditions have been addressed, a problem that arises in the development of systems for operating electrochemical processes is how individual constituents of the electrochemical cells can be manufactured on an industrial scale.

It is therefore in the interest of energy efficiency to keep the internal resistance of the electrochemical cell as low as possible. This can be enabled with a compact construction, by placing the electrodes particularly close to the separator and also placing the electrocatalyst as close as possible to the respective electrode.

One way to achieve this compact construction is the aforementioned CCM design where the anion exchange membrane is provided with a coating containing catalytically active/catalytically activatable material. Prepared in this way the anion exchange membrane thus already incorporates the electrocatalyst upon assembly of the cell. This obviates the need for handling the catalyst during assembly of the cell and a compact cell construction which allows a low internal resistance is achieved.

When coating anion exchange membranes with electrocatalysts, it should be noted that the substrate (membrane) and coating material (catalyst) are very different materials: the membrane generally consists of an ion-conducting specialty polymer (ionomer) in the form of a film while the electrocatalyst employed is typically in the form of metals or metal oxides in particulate form. In order to immobilize the catalytically active particles on the film, polymeric adhesion promoters which adhesively bond the particles to the membrane are used. The adhesion promoters may also be ionomers, made of a material such as that of the anion exchange membrane.

Due to the heterogeneity of the materials involved, the production of CCM is non-trivial. The handling of the materials during the coating is also challenging.

One process that is implemented both in the manufacture and in the industrial production of CCM is the so-called decal process. In this process the catalyst is initially mixed with a thermoplastic adhesion promoter to form a coating compound and this is applied to a transfer substrate, usually a PTFE film. The coated transfer substrate is then pressed with the anion exchange membrane and heated. The thermoplastic melts and adhesively bonds the catalyst particles to the membrane. The PTFE film is then removed from the membrane like a decal and discarded. A coating remains on the membrane, consisting of the adhesion promoter and the catalyst particles immobilized therein.

An overview of the decal process is provided in:
Frölich, Konstantin: “Der Decal-Prozess zur Herstellung katalysatorbeschichteter Membranen für PEM-Brennstoffzellen Schriftenreihe des Instituts für Angewandte Materialien, Karlsruher Institut für Technologie.” DOI: 10.5445/KSP/1000045306

Although Frölich describes the decal process in terms of CCM intended for use in PEM fuel cells (PEM stands for Proton Exchange Membrane-proton-conducting membrane) the teaching therein can in principle also be applied to CCM as are to be employed in AEM-based water electrolysis.

However, fundamental disadvantages of the decal process are conceded: thus for example the decal process requires high pressure and high temperatures during pressing in order that the adhesion promoter correspondingly joins the catalyst particles to the membrane material. However, the membrane materials used in alkaline water electrolysis are often very temperature-sensitive with the result that the temperatures normally run in the decal process are too high. This applies all the more if an anion-conducting polymer is to be employed as the adhesion promoter.

A further inherent disadvantage of the decal process is the necessary use of a transfer substrate. These transfer substrates-usually films made of PTFE—are removed from the coated membrane and discarded after coating or at the latest before installation of the CCM into the cell (lost film). This is concerning for environmental reasons, especially when fluorine-containing polymers such as PTFE are employed as the film material for the transfer substrate.

It is therefore of interest to develop a process for producing a CCM employable in alkaline membrane water electrolysis which eschews a transfer film. The ion exchange membrane shall especially be directly coated with the catalytically active or activatable layer.

A corresponding direct coating process has already been proposed by Koch et al.:
Koch, S., Metzler, L., Kilian, S. K., Heizmann, P. A., Lombeck, F., Breitwieser, M., Vierrath, S., Toward Scalable Production: Catalyst-Coated Membranes (CCMs) for Anion-Exchange Membrane Water Electrolysis via Direct Bar Coating. Adv. Sustainable Syst. 2023, 7, 2200332. DOI: 10.1002/adsu.202200332

Therein, a flat, anion-conducting membrane is initially masked with a PTFE film and directly coated in its free areas with a catalyst-containing composition. A protective film likewise made of PTFE is additionally attached by adhesive bonding. The mask is used to absorb stresses in the membrane to ensure that the membrane does not warp excessively during coating. The change in shape of the membrane is due to the solvent (water and methanol) present in the composition swelling the membrane material: the penetration of the solvent mixture into the membrane material causes the volume of the membrane to increase during coating, so that mechanical stresses which altogether lead to distortion of the coated membrane are introduced into the interface layer between the catalyst and the membrane. In extreme cases the coated membrane forms wrinkles. Installation of a distorted or even wrinkled CCM in an electrochemical cell is hardly possible.

However, even minor deviations from the planarity of the CCM have the result that the sealing elements of the electrochemical cell are not properly seated in the contact region of the CCM, thus leading to possible leaks in the electrochemical cell. Because many electrolyses produce potentially toxic or explosive gases, clean sealing of the cell is indispensable. This is only achievable with a sufficiently wrinkle-free CCM. However, even during production of the CCM, swelling of the membrane should be avoided to the greatest possible extent since it reduces the processability on coating machines: Thus especially belt transport in rational roll-to-roll processes is impeded. For all these reasons the Susanne Koch research group used the masking film to reduce distortion of the membrane during coating.

The disadvantage of the process proposed by Koch et al. is that it requires the masking film to prevent swelling of the membrane and thus ultimately wrinkle formation. Similarly to the transfer substrate in a decal process the mask serves exclusively for production of the CCM and must be removed from the CCM again in the ready-to-use state. The mask must therefore also be considered to be a lost film. The process also requires a lot of manual work and does not yet appear to be scalable from an industrial standpoint.

In addition, the composition used by Koch et al. for coating the AEM contains methanol as solvent for the adhesion promoter. Since methanol is known to be carcinogenic, mutagenic or toxic to reproduction this solvent is classified as a CMR substance according to GHS, thus requiring appropriate safety measures when used. This does not cause any great difficulties in the laboratory but on an industrial production scale this is very complex and thus costly.

WO2023088714A1 discloses a composition containing a dissolved anion-conducting ionomer and an electrocatalyst. As solvent for the anion-conducting polymer the composition contains dimethyl sulfoxide (DMSO) and additionally an ethanol/water mixture as dispersing medium. None of these substances are classified as CMR-relevant. This composition is used to produce CCM or CCS that may be used in AEMWE. In the experimental part of WO2023088714A1 an ultrasonic spray coater is used for direct application of the composition to various substrates. Subsequent experiments set out therein show that an AEM coated with this composition forms wrinkles.

CN 115832338 A discloses a machine for producing a CCM intended for a PEM fuel cell. The machine performs a roll-to-roll process. The temperature management is adapted to reduce the swelling of the membrane. The processed ionomer conducts only protons and is therefore unsuitable for use in AEMWE.

EP4223417A1 describes a coating composition for producing a water electrolysis cell. The composition contains a nickel-iron (oxide) hydroxide as electrocatalyst, an organic polymer and a solvent. In this formulation, solvents and polymers are selected such that the Hansen parameters of these two components maintain a certain geometric distance from the Hansen parameters of the electrocatalyst. The examples test different solvent mixtures, for instance a mixture of 1-propanol and ethanol or of 2-propanol and water. The Hansen parameters of these solvents are shown in table 1. The organic polymer is in each case Nafion®, a proton-conducting fluoropolymer. Said polymer is inherently unsuitable for use as an ion conductor in AEM-based water electrolysis since it does not conduct hydroxide ions OH⁻. There are also increasing reservations about its use due to its fluorine content.

WO2023183721A2 describes a composition containing a carbon-supported noble metal catalyst, wherein the solvent present is water and at least one substance selected from 1-propanol, 2-propanol, NMP, DMAC, DMSO, DMF and cyclopentanone. Since the solvents N,N-dimethylacetamide (DMAC), N,N-dimethylformamide (DMF) and N-methyl-2-pyrrolidone (NMP) are all known to be carcinogenic or mutagenic or reprotoxic, they are all classified as CMR substances according to GHS and therefore require costly safety measures when used industrially, as discussed above. The composition described in WO2023183721A2 is moreover directed to the production of CCS as employed in high temperature fuel cells. This requires special proton-conducting ionomers.

Various CMR-free compositions for production of a CCM intended for AEMWE are specified in European patent application No. 24159645.1 by the same applicant which was not yet published at the time of the present application. They contain the solvents dimethyl sulfoxide, ethanol and/or 2-propanol with acetonitrile and water.

A further European patent application No. 24152389.3 by the same applicant which was not yet published at the time of the present application likewise relates to a composition containing an electrocatalyst, ionomer and solvent. The solvent is a mixture of dimethyl sulfoxide, ethanol and a little acetonitrile. This composition is also intended for production of a CCM employable in alkaline water electrolysis.

Yet a further European patent application No. 24169671.5 by the same applicant which was not yet published at the time of the present application mentions a catalyst ink containing at least one first solvent, at least one polymer dissolved in the first solvent, at least one particulate electrocatalyst which is electrocatalytically active or activatable and at least one particulate inorganic material distinct from the electrocatalyst. Contemplated solvents include dimethyl sulfoxide (DMSO), ethanol (EtOH), acetonitrile (ACN) or methanol (MeOH). The catalyst ink may moreover also contain a dispersing medium, for example water (H₂O), N-methyl-2-pyrrolidone (NMP), N,N-dimethylacetamide (DMAC), acetone (ACT), 2-propanol (IPA). The particular feature of this catalyst ink is that it is intended for application to a transfer substrate and not for application to an anion exchange membrane.

### BRIEF DESCRIPTION OF THE DRAWINGS

FIG. 1: Membrane coated with conventional composition.

FIG. 2: Membrane coated with inventive composition.

FIG. 3A: Commercial anion exchange membrane coated with inventive composition.

FIG. 3 B: Commercial anion exchange membrane coated with conventional composition.

FIG. 4: Characteristic current/voltage lines.

### DETAILED DESCRIPTION

Having regard to this prior art it is an object of the invention to specify a process for producing a coated anion exchange membrane by direct coating with electrocatalytically active or activatable material which maintains the necessary planarity of the AEM and ideally eschews the use of lost films. The catalytically coated anion exchange membranes (CCM) shall be employable in alkaline water electrolysis. To allow improved processability in industrial-scale mechanized production, swelling shall be minimized. The process shall also be performable with fluorine-free ionomers and ideally eschew CMR substances.

This object is achieved by a process comprising the following non-chronological steps:
a) providing a viscous composition containing at least the following components:
   i) an electrocatalyst;
   ii) a solvent;
   iii) an anion-conducting polymer;
b) providing an anion exchange membrane containing at least one membrane material;
c) applying the viscous composition to the anion exchange membrane;
d) drying the viscous composition applied to the anion exchange membrane;
e) obtaining a coated anion exchange membrane which comprises at least on one side a layer comprising the electrocatalyst and the anion-conducting polymer, wherein the electrocatalyst is joined to the membrane material via the anion-conducting polymer;
wherein the anion-conducting polymer, the membrane material and the solvent are selected to be matched to one another such that the anion-conducting polymer and the membrane material are each soluble in the solvent;
characterized
in that the viscous composition additionally contains the following component:
   iv) an organic substance distinct from the solvent;
wherein the solubility parameters δD, δP and δH of the organic substance determined according to Hansen are in the following ranges:

$$15 {MPa}^{0.5} < δ D < 35 {MPa}^{0.5}$$

$$6 {MPa}^{0.5} < δ P < 15 {MPa}^{0.5}$$

$$2.5 {MPa}^{0.5} < δ H < 7.1 {MPa}^{0.5}$$

An essential feature of the invention is that the membrane material, the anion-conducting polymer, the solvent and the additionally present organic substance are selected to be matched to one another. The matching is carried out in respect of the dissolution behaviour of the solvent having regard to the membrane material and the anion-conducting polymer. The solvent is specifically selected such that it dissolves both the membrane material and the anion-conducting polymer present in the composition.

The question of lone solubility can be clarified by the following test: a vessel is charged with 27 g of the organic substance to be investigated and 3 g of the anion-conducting polymer/membrane material to be investigated. No other organic substances are added. The vessel is sealed and shaken at 60° C. for 4 h. If the anion-conducting polymer or the membrane material is dissolved by this procedure, the anion-conducting polymer or the membrane material is soluble in the investigated organic substance alone in the context of the present invention. If the anion-conducting polymer or the membrane material does not dissolve during this treatment it is not soluble alone in the investigated substance.

The question of whether an anion-conducting polymer or membrane material is dissolvable in a combination of two organic substances is answered by the following experiment:

A vessel is charged with 13.5 g of the first organic substance to be investigated and 13.5 g of the second organic substance to be investigated. 3 g of the anion-conducting polymer or membrane material to be investigated is added to this vessel. No other organic substances are added. The vessel is sealed and shaken at 60° C. for 4 h. If the anion-conducting polymer or the membrane material is dissolved by this procedure, the anion-conducting polymer or the membrane material is soluble in the combination of the two investigated organic substances in the context of the present invention. Otherwise it is insoluble.

The invention is based on the finding that the addition of certain organic substances to the composition has the result that said composition swells the anion exchange membrane only to a small extent, if at all. The additionally present organic substance is therefore also referred to as an “antiswelling agent”.

Since the solvent is generally also an organic substance, the viscous composition contains at least two organic substances, namely the solvent and the antiswelling agent.

These two organic substances fulfil two functions within the system of the viscous composition: A first function is to dissolve the anion-conducting polymer. The first function is therefore that of a solvent. The second function is to prevent swelling of the anion exchange membrane. The second function is therefore that of an antiswelling agent. These two functions are only required during the coating operation. Both organic substances are evaporated by drying after coating. The anion-conducting polymer is thus precipitated from the solution and immobilises the electrocatalyst on the anion exchange membrane.

After drying, the electrocatalyst and the anion-conducting polymer form the catalytically active coating of the anion exchange membrane. The anion-conducting polymer serves as an adhesion promoter which immobilises the electrocatalyst on the anion exchange membrane by connecting the electrocatalyst to the membrane material.

It has surprisingly been found that substances suitable as antiswelling agents are in both cases identifiable by their solubility behaviour, more precisely by their solubility parameters determined according to Hansen δD, δP and δH. These are referred to for short as “Hansen parameters” and were first described by:
Hansen, Charles. M.: The Universality of the Solubility Parameter. Ind. Eng. Chem. Prod. Res. Dev. 1969, 8, 1, 2-11 DOI 10.1021/i360029a002

The Hansen parameters of contemplated substances may be found in the literature or may be measured. The measuring temperature is 20° C. Table 1 lists the Hansen parameters of the substances considered here. In the case of doubt, the values in table 1 apply.

According to the invention the organic substances (antiswelling agents) selected are substances whose Hansen parameters are in the following ranges:

$$15 {MPa}^{0.5} < δ D < 35 {MPa}^{0.5}$$

$$6 {MPa}^{0.5} < δ P < 15 {MPa}^{0.5}$$

$$2.5 {MPa}^{0.5} < δ H < 7.1 {MPa}^{0.5}$$

These requirements are to be understood as meaning that all three conditions must be met cumulatively. If only one of the three Hansen parameters δD, δP and δH is outside the respective range defined above, the organic substance fails to perform the function intended according to the invention.

It is preferable when δD<20 Mpa^{0.5} additionally applies.

The effect which prevents swelling of the ionomers appears to be attributable to the solubility or crosslinking behaviour of the added organic substance. Polar substances having a low dipolar interaction and low energy from hydrogen bonds appear to be advantageous. Due to their mode of action the organic substances in question are presently described as “antiswelling agents”.

Specific substances that are suitable as the organic substance (antiswelling agent) include (1S,5R)-6,8-dioxabicyclo[3.2.1]octan-4-one, cycloheptanone, cyclohexanone and cyclopentanone. That is because these substances exhibit excellent antiswelling behaviour, are not listed as CMR substances and are even obtainable from renewable raw materials. Employable antiswelling agents likewise include benzonitrile, butanone, acetone and acetophenone.

It is in principle also possible to employ a plurality of individually suitable antiswelling agents as an antiswelling agent mixture. If two or more antiswelling agents are employed as a mixture, the weight fraction of the antiswelling agent mixture is used as the weight fraction of the antiswelling agent. Each individual antiswelling agent present in the antiswelling agent mixture must meet the defined parameters in terms of its Hansen parameters.

According to the invention, antiswelling agents and solvents are chemically distinct. They are particularly preferably also functionally distinct, meaning that the antiswelling agent cannot simultaneously serve as a solvent. This is why the anion-conducting polymer, the membrane material and the organic substance are preferably selected to be matched to one another such that the anion-conducting polymer and the membrane material are each insoluble in the organic substance. The insolubility is tested using the above-described test.

The following solvents have proven particularly advantageous for mixing the viscous composition: dimethyl sulfoxide, ethanol, 1-propanol, 2-propanol, acetonitrile. These solvents are also CMR-free.

It goes without saying that it is also possible to employ a plurality of these solvents together as a solvent mixture. The foregoing relating to an individual solvent applies accordingly to the weight fraction of the solvent mixture.

It is preferable when the anion-conducting polymer is completely dissolved in the solvent/the solvent mixture when the viscous composition is provided and/or applied. This facilitates application because the viscous composition is then free of lumps. During drying the solvent evaporates, thus causing the anion-conducting polymer to precipitate from the solution.

In addition to the four basic components of electrocatalyst, solvent, anion-conducting polymer and antiswelling agent, the viscous composition employed according to the invention may also contain further components. It is particularly preferable when it additionally contains a dispersing medium distinct from the solvent and the antiswelling agent. Water is recommended as the dispersing medium. The dispersing medium is utilized to adjust the viscosity of the composition. The dispersing medium is at least partially volatilized during drying.

The catalyst-containing viscous composition with which the AEM is coated may have different degrees of viscosity: on the one hand it is conceivable for the viscous composition to be rather pasty. The viscous composition is then also referred to as “catalyst paste”. A catalyst paste is highly viscous. However, the viscous composition can also have a very low dynamic viscosity (mobile). In this form the composition tends to be referred to as a “catalyst ink”.

It is also conceivable for the viscosity of the composition to change during processing: in this case the viscous composition may be provided as a paste but applied as an ink. This is possible by adjusting the processing temperature which markedly affects the dynamic viscosity of the viscous composition.

The dynamic viscosity η may be quantified with a characteristic value. The characteristic value of the dynamic viscosity η of the composition should be between 10¹ mPas and 10⁴ mPas. The dynamic viscosity η is measured at a temperature of 25° C. with a rotational rheometer with plate-plate geometry. The diameter of the plates is 40 mm and the distance between the plates is 1 mm. The dynamic viscosity is measured at increasing shear speeds between 0.1 s⁻¹ and 1000 s⁻¹ and the characteristic value used is the dynamic viscosity at 1 s⁻¹. A suitable rotational rheometer with plate-plate geometry is available, for example, from Malvern Kinexus.

In order not to introduce into the catalyst layer of the anion exchange membrane any disruptive substances that could impair the electrolysis, the viscous composition should ideally consist exclusively of the previously explicitly recited components. However, in some circumstances it may still be necessary to add to the composition a further component distinct from the aforementioned components. This may be selected from organic or inorganic additives, for instance a dispersing aid or a rheology aid or a surfactant or a conductivity additive. Specific examples of further components are silica or carbon black. Carbon black is a conductivity additive, and silica is suitable as a rheology aid.

Specifications for a specific formulation for the viscous composition employed according to the invention are set out in table 2.

TABLE 2
Specifications for a specific formulation

| | Minimum | Maximum |
|---|---|---|
| | content (% by | content (% by |
| Component | wt.) | wt.) |
| Electrocatalyst | 1 | 30 |
| Solvent or solvent mixture | 10 | 40 |
| Organic substance (antiswelling agent) | 45 | 90 |
| Anion-conducting polymer | 0.1 | 10 |
| Dispersing medium | 0 | 20 |

The weight fractions specified in table 2 are in each case based on the total weight of the viscous composition. It goes without saying that the sum of the weight fractions of all components listed here does not exceed 100% by weight. However, it is likewise possible for the sum of the weight fractions of all components listed here to be below 100% by weight, namely when a further component distinct from the listed components is present.

It is preferable when the electrocatalyst is present in particulate form, i.e. as powder or granulate. Powder is a dosage form that is easily mixable into a catalyst paste or ink by addition of polymer, solvent and antiswelling agent.

The electrocatalyst must contain at least one electrocatalytically active element which accelerates the intended electrochemical reaction. Examples of such electrocatalytically active elements include iridium (Ir), nickel (Ni), cobalt (Co), chromium (Cr), iron (Fe), ruthenium (Ru), copper (Cu), molybdenum (Mo), zinc (Zn), lead (Pb), manganese (Mn), tungsten (W), platinum (Pt), sulfur(S), tin (Sn), gold (Au), silver (Ag), palladium (Pd), rhenium (Re), rhodium (Rh) and cerium (Ce). These elements may be present either in pure form or as oxide or as hydroxide or as oxide hydroxide or as phosphide. In addition to the electrocatalytically active element, the electrocatalyst may also contain a support material, for instance carbon.

In alkaline water electrolysis, especially three electrocatalysts have proven advantageous, namely platinum or platinum alloy supported on carbon (Pt/C) or nickel-iron (oxide) hydroxide (NiFeₐO_{b}H_{c}) or nickel-iron phosphide (NiFeₐP_{b}), wherein the indices a, b, and c are each a real number from the interval of 0 to 8 inclusive. The viscous composition thus preferably contains a Pt/C or NiFeₐO_{b}H_{c} or NiFeₐP_{b} electrocatalyst.

Due to its particulate dosage form the electrocatalyst can achieve a large specific surface area. This allows good accessibility of the catalytically active centres for the reaction participants, thus in turn increasing the efficiency of the reaction. In addition, the electrocatalyst is thus better utilized because hardly any electrocatalytically active material remains unreached and unutilized in the interior of the catalyst. This makes it possible to reduce the material costs for the electrocatalyst, as is of interest especially for costly or rare noble metal catalysts. A large specific catalyst surface area thus has many advantages. The specific surface area may be easily increased by employing the particulate electrocatalyst with a particularly fine particle size. The finer the particles, the greater the specific surface area. It is also possible to increase the specific surface area of the electrocatalyst by employing porous material.

The specific surface area of the electrocatalyst should be between 0.5 m²/g and 2000 m²/g or between 20 m²/g and 200 m²/g. The specific surface area is determined by the method described by Brunauer-Emmett-Teller (BET method), namely by nitrogen adsorption. The BET procedure may be performed in automated fashion with commercially available particle analysers, such as a Micromeritics ASAP 2460 instrument.

It is preferable to employ an anion-conducting polymer containing at least one structure conforming to any of formulae (I), (II), (III):

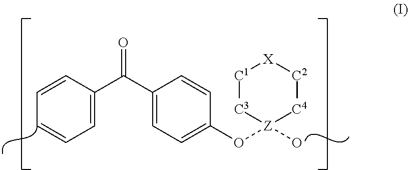

wherein, in (I), X is a structural element comprising a positively charged nitrogen atom which is bonded to C¹ and C² and which is bonded via two bonds to one or two hydrocarbon radicals, comprising 1 to 12, preferably 1 to 6, particularly preferably 1 or 5, carbon atoms
and wherein, in (I), Z is a structural element comprising a carbon atom which is bonded to C³ and C⁴ and which comprises at least one aromatic six-membered ring bonded directly to one of the oxygen atoms, wherein the aromatic six-membered rings may be substituted with one or more halogen radicals and/or one or more C₁- to C₄-alkyl radicals;

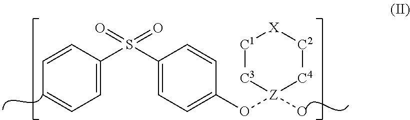

wherein, in (II), X is a structural element comprising a positively charged nitrogen atom which is bonded to C¹ and C² and which is bonded via two bonds to one or two hydrocarbon radicals, comprising 1 to 12, preferably 1 to 6, more preferably 1 or 5, carbon atoms,
and wherein, in (II), Z is a structural element comprising a carbon atom which is bonded to C³ and C⁴ and which comprises at least one aromatic six-membered ring bonded directly to one of the oxygen atoms, where the aromatic six-membered ring may be substituted in positions 3 and 5 with the same or different C₁- to C₄-alkyl radicals, in particular with a methyl, isopropyl or tert-butyl group, preferably a methyl group;

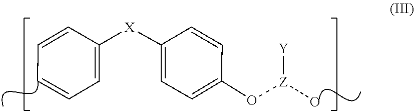

wherein, in (III), X is a ketone or sulfone group;
wherein, in (III), Z is a structural element comprising at least one tertiary carbon atom and at least one aromatic six-membered ring, wherein the aromatic six-membered ring is bonded directly to one of the two oxygen atoms;
and wherein, in (III), Y is a structural element comprising at least one positively charged nitrogen atom, wherein this nitrogen atom is bonded to the structural element Z.

Such ionomers are described in patent applications EP3770201A1, EP4032934A1 and EP4059988A1. They have good anion conductivity, hardly swell and are free from fluorine.

It is preferable when the membrane material and the anion-conducting polymer comprise the same repeating unit or are even identical. In particular, ionomers which contain at least one of the structures (I), (II) or (III) may be used both as anion-conducting polymers in the composition and as membrane material. This not only improves the adhesion of the electrocatalyst to the membrane but also facilitates the matching of the system of anion-conducting polymer, membrane material, solvent and antiswelling agent because the system then has only three dimensions instead of four.

Since the catalyst-containing coating composition hardly swells the AEM on account of the antiswelling agent present therein the membrane can also be directly coated without complex immobilization and is more readily amenable to wrinkle-less processing. It is especially possible to apply the viscous composition to the anion exchange membrane without the use of lost films such as transfer films or masking films. This avoids waste and especially the production of fluoropolymers such as PTFE.

A particular advantage of the viscous composition described here is that it hardly swells the anion exchange membrane to be coated, if at all. The viscous composition is therefore particularly suitable for direct coating of the AEM. This means that the application of the viscous composition to the anion exchange membrane is effected by applying the viscous composition directly to the anion exchange membrane, namely without the use of a transfer substrate as is customary in the decal processes.

Especially when CMR-free antiswelling agents such as for example cycloheptanone, (1S,5R)-6,8-dioxabicyclo[3.2.1]octan-4-one, cyclohexanone, cyclopentanone, benzonitrile, butanone, acetone, acetophenone and CMR-free solvents such as dimethyl sulfoxide, ethanol, 1-propanol, 2-propanol or acetonitrile are utilized, the production process according to the invention makes it possible to save production costs because the safety requirements for using these substances are lower. A particular embodiment of the process therefore provides that the solvent and the antiswelling agent are additionally selected such that they are not designated as carcinogenic, mutagenic or reprotoxic. This is the case when the substance is not classified as a CMR substance according to the Globally Harmonized System of Classification, Labelling and Packaging of Chemicals of the UN. Table 1 specifies which substances are considered as CMR-free. The GHS in its current version is binding in this respect.

The advantages of the production process according to the invention have an effect not only on production costs but also result in a better product: experiments show that coating with the composition described here results in better efficiency of the AEM coated therewith which is attributable to better coating quality. The invention therefore likewise provides a catalytically coated AEM which is obtainable by the coating process according to the invention.

An anion exchange membrane coated according to the invention contains a membrane material and at least one layer comprising an electrocatalyst and an anion-conducting polymer, wherein the electrocatalyst is joined to the membrane material via the anion-conducting polymer. Due to the antiswelling agent present in the composition the anion exchange membrane coated according to the invention contains traces and/or decomposition products of the antiswelling agent. Traces are residues of the antiswelling agent that have not fully evaporated during drying. Decomposition products are produced when the antiswelling agent degrades. The nature of the traces or decomposition products that are present in the anion exchange membrane depends on the specific antiswelling agents employed. It is preferable when the AEM coated according to the invention comprises traces or decomposition products of (1S,5R)-6,8-dioxabicyclo[3.2.1]octan-4-one or cyclohexanone or cyclopentanone or cycloheptanone or benzonitrile or butanone or acetone or acetophenone. The invention further provides such a coated anion exchange membrane.

It is to be expected that the weight fraction of the antiswelling agent or its decomposition product is between 0% by weight and 10% by weight, wherein the weight fraction is based on the total weight of the coated anion exchange membrane.

Since the advantages of the anion exchange membrane coated according to the invention are especially evident in AEMWE, namely in an improvement in efficiency, the invention further provides for the use of a catalytically coated anion exchange membrane according to the invention in alkaline water electrolysis. The use occurs when alkaline water electrolysis is performed in the presence of the catalytically coated anion exchange membrane. The electrocatalyst present in the coating catalyses the alkaline water electrolysis. The coating can simultaneously serve as an electrode. The membrane and the ionomer present in the coating transports hydroxide ions OH⁻ from the cathodic compartment of the electrochemical cell to the anodic compartment.

### EXAMPLES

The process for producing a catalytically coated AEM with the help of a platinum/carbon-based viscous composition is described below. The effects achieved by the invention are thus verified experimentally.

### 1. Producing an Ionomer (not Part of the Invention)

An anion-conducting cationic polymer was synthesized in accordance with Example 3 of EP3770201A1. This polymer was initially provided as a solution and was processed into a powder by drying. To minimize the residual solvent content the dried polymer was then dried for a further 48 h in a vacuum drying cabinet at 80° C.

Dry powder was used to prepare two different ionomer solutions used in the following examples:

### 1.1 Production of a 20% Ionomer Solution (not Part of the Invention)

Firstly a 20% ionomer solution was produced by mixing 20 parts by weight of the dry polymer powder with 80 parts by weight of DMSO. The mixture was initially heated to 60° C. in a sealed vessel and subsequently shaken for 24 h using a nutating mixer until the polymer was completely dissolved.

### 1.2 Production of a 12% Ionomer Solution (not Part of the Invention)

Secondly, a 12% ionomer solution was produced by further diluting the previously produced 20% solution to 12% by weight by adding acetonitrile and ethanol in equal weight fractions. The mass fractions in the solution were 12 parts by weight of polymer, 48 parts by weight of DMSO and in each case 20 parts by weight of acetonitrile and ethanol. To ensure complete mixing the sealed vessel was likewise shaken in the nutating mixer for 24 hours.

### 2. Experiment on Solubility of the Ionomer in Ethanol, 1-Propanol and 2-Propanol

To this end three vessels were prepared, the first with 27 g of ethanol, the second with 27 g of 1-propanol and the third with 27 g of 2-propanol. Added to these vessels were in each case 3 g of the cationic polymer powder synthesized from example 1, and the vessels were sealed and shaken at 60° C. for 4 h. The result in each case was a slightly swollen, softened lump of the polymer, which had not significantly dissolved, at the bottom of the vessel.

### 3. Experiment on Solubility of the Ionomer in Acetonitrile

To this end 3 g of the cationic polymer powder synthesized from example 1 was added to a vessel containing 27 g of acetonitrile and the resulting mixture was shaken at 60° C. for 4 h. The result here too was that no significant dissolution of the polymer was apparent.

### 4. Experiment on Solubility of the Ionomer in a Mixture of Ethanol or 1-Propanol or 2-Propanol in Combination with Acetonitrile

To this end three vessels were prepared, the first with 13.5 g of ethanol and 13.5 g of acetonitrile, the second with 13.5 g of 1-propanol and 13.5 g of acetonitrile, and the third with 13.5 g of 2-propanol and 13.5 g of acetonitrile. Added to these vessels were in each case 3 g of the cationic polymer powder synthesized from example 1, and the vessels were shaken at 60° C. for 4 h. The result was a virtually clear solution. The polymer had dissolved in all three vessels.

### 5. Interim Findings: Solubility Behaviour of the Ionomer

The investigated ionomer is dissolvable in a solvent mixture of ethanol and acetonitrile but not in ethanol or acetonitrile alone. The same applies to the mixture of 1-propanol with acetonitrile and the mixture of 2-propanol with acetonitrile.

### 6. Producing an Anion Exchange Membrane (not Part of the Invention)

The cationic polymer synthesized in example 1 was used to produce an anion-conducting membrane, as described in Example 4 of EP3770201A1. The polymer solution before drying was used therefor.

### 7. Providing a Composition without Antiswelling Agent (not Part of the Invention)

The cationic polymer synthesized in example 1 was used to produce a viscous composition, as described in example 12 of WO2023088714.

The ionomer was initially dissolved in dimethyl sulfoxide with stirring and temperature (60° C.) for 16 h. Subsequently, the platinum on carbon (Pt/C, ˜50% by weight) catalyst was dispersed in the dispersing medium composed of equal volume fractions of water and ethanol using ultrasound (BRANSONIC™ B-1200 E2 from Branson Ultrasonics Corporation, Brookfield, CT, US) in an ice bath for 30 min at a power of 30 W. Addition of the ionomer solution is followed by further dispersion using ultrasound in an ice-bath for 1 min at 30 W and dispersion using a shaker (MS1 Minishaker from IKA, Staufen, DE) for 10 s at 2500 rpm. The contents were selected according to table 1, example 12. The solids content was thus set at 11 mg/ml, with a content of Pt/C catalyst particles of 3 parts by mass and a content of ionomer solid of 1 part by mass. This resulted in a low-viscosity composition.

### 8. Providing a Composition Comprising Antiswelling Agent (Part of the Invention)

As an inventive composition 20.9 g of catalyst-containing ink was prepared. To this end, initially 3 g of Pt/C (Pt˜50% by weight) was weighed into a shatterproof vessel (volume 100 ml) in an oxygen-free atmosphere, followed by addition of 8.6 g of (1S,5R)-6,8-dioxabicyclo[3.2.1]octanon-4-one (Cyrene®, Sigma Aldrich, Germany), 0.5 g of DMSO, 1 g of ethanol, 1 g of acetonitrile and 4.3 g of cyclopentanone. Finally, 30 g of yttrium-stabilised zirconium grinding balls were added. The mixture was dispersed in a shaker mixer (Lau, Germany) for 2 hours. Subsequently, 2.5 g of ionomer solution (20% by weight in DMSO—example 1.1) was added and finally shaken for 5 minutes by shaker mixer.

In this example DMSO, EtOH, and ACN form a solvent mixture. Cyrene® and cyclopentanone form an antiswelling agent mixture.

### 9. Coating a Membrane with the Conventional Composition without Antiswelling Agent (not Part of the Invention)

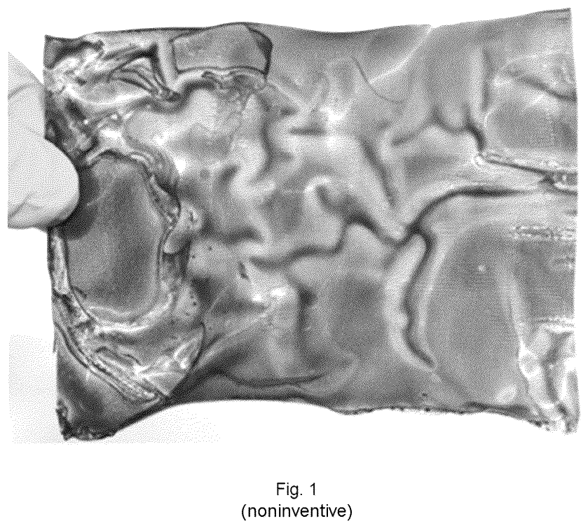

For the reference experiment with the conventional formulation from WO2023088714, Example 12, the composition provided under 7 was applied using an automatic bar coater (Elcometer 4340, advance rate 5 mm/s, spiral bar coater, 60 μm) to the membrane produced in Example 6. The coated membrane was then dried at 80° C. for 15 min in a laboratory oven. The result is a CCM as shown in FIG. 1.

FIG. 1: Membrane Coated with Conventional Composition

During the coating the membrane underwent severe rippling, thus resulting in an inhomogeneous coating, but is nevertheless suitable in principle as an electrode for water electrolysis.

### 10. Coating a Membrane with the Composition Comprising Antiswelling Agent (Part of the Invention)

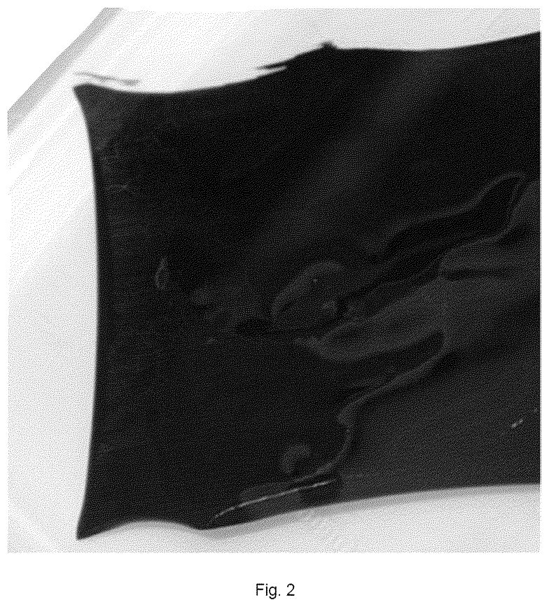

For inventive direct coating using the antiswelling agent-containing formulation the composition provided under 8 was applied to the membrane produced in example 6 using an automatic bar coater (Elcometer 4340, advance rate 5 mm/s, spiral coating bar, 60 μm). The coated membrane was then dried at 80° C. for 15 min in a laboratory oven. The result is a CCM as shown in FIG. 2.

FIG. 2: Membrane Coated with Inventive Composition

During coating the membrane underwent only marginal rippling, thus resulting in a homogeneous coating suitable as an electrode for water electrolysis.

### 11. Coating an Alternative Commercial Membrane with the Composition Comprising Antiswelling Agent (Part of the Invention)

As an inventive composition 23.5 g of catalyst-containing ink was prepared. To this end, initially 3 g of Pt/C (Pt˜50% by weight) was weighed into a shatterproof vessel (volume 100 ml) in an oxygen-free atmosphere, followed by addition of 18.0 g of cyclopentanone. Finally, 30 g of yttrium-stabilised zirconium grinding balls were added. The mixture was dispersed in a shaker mixer (Lau, Germany) for 2 hours. Subsequently, 3.0 g of the 12% ionomer solution described in 1.2 was added (12% polymer, 48% DMSO, 20% ethanol, 20% acetonitrile) and the resulting mixture was finally shaken for 5 minutes using a shaker mixer.

In this example DMSO, EtOH, and ACN form a solvent mixture. The antiswelling agent is cyclopentanone.

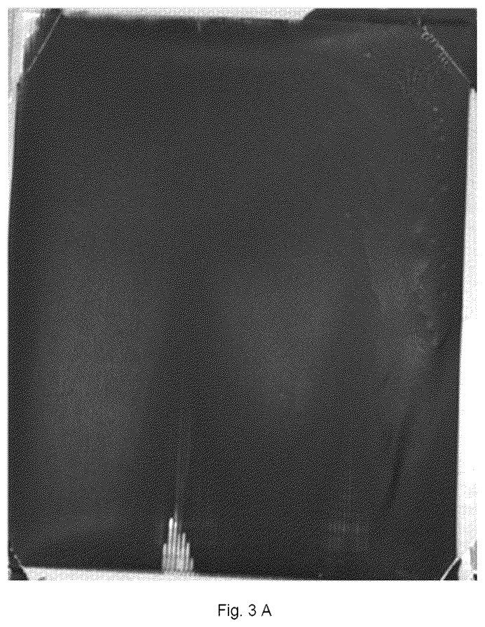

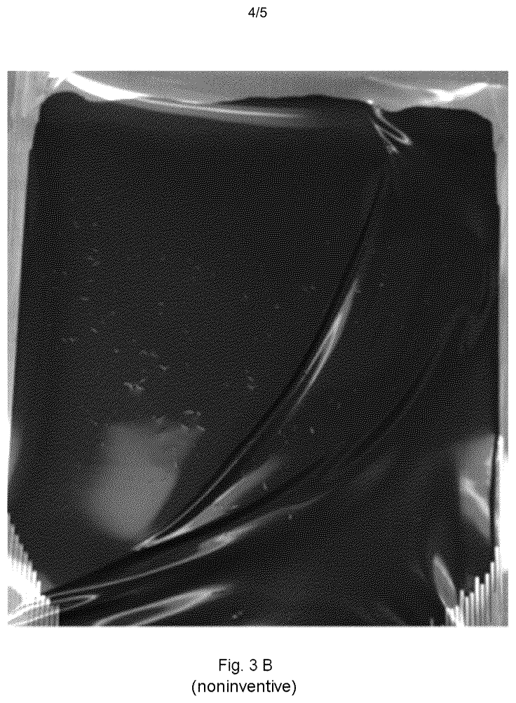

For inventive direct coating using the antiswelling agent-containing formulation the composition described in this example was applied to a commercial anion exchange membrane (FAA-3-50, Fumatech BWT GmbH, Germany) using an automatic bar coater (Elcometer 4340, advance rate 5 mm/s, spiral coating bar, 60 μm). The coated membrane was then dried at 80° C. for 15 min in a laboratory oven. The result is a CCM as shown in FIG. 3A.

FIG. 3A: Commercial Anion Exchange Membrane Coated with Inventive Composition

During coating the membrane underwent only marginal rippling, thus resulting in a homogeneous coating suitable as an electrode for water electrolysis.

### 12. Coating the Alternative Commercial Membrane with a Conventional Composition without Antiswelling Agents (not Part of the Invention)

As a noninventive composition, 10.0 g of catalyst-containing ink was prepared. To this end, initially 2.0 g of Pt/C (Pt˜50% by weight) was weighed into a shatterproof vessel (volume 100 ml) in an oxygen-free atmosphere, followed by addition of 3.0 g of water, 1 g of DMSO and 4.0 g of the 12% ionomer solution described at 1.2 (12% polymer, 48% DMSO, 20% ethanol, 20% acetonitrile). Finally, 30 g of yttrium-stabilised zirconium grinding balls were added. The mixture was dispersed in a shaker mixer (Lau, Germany) for 2 hours.

In this example DMSO, EtOH, and ACN form a solvent mixture. No antiswelling agent was used.

For noninventive direct coating, the formulation described in this example was applied to a commercial anion exchange membrane (FAA-3, Fumatech BWT GmbH, Germany) using an automatic bar coater (Elcometer 4340, advance rate 5 mm/s, spiral bar coater, 60 μm). The coated membrane was then dried at 80° C. for 15 min in a laboratory oven. The result is a CCM as shown in FIG. 3 B.

FIG. 3 B: Commercial Anion Exchange Membrane Coated with Conventional Composition

In the coating, the membrane exhibits a much greater degree of rippling compared to the membrane shown in FIG. 3A, thus resulting in a less homogeneous coating.

### 13. Testing the Coated Membranes in an Electrolysis Test Cell

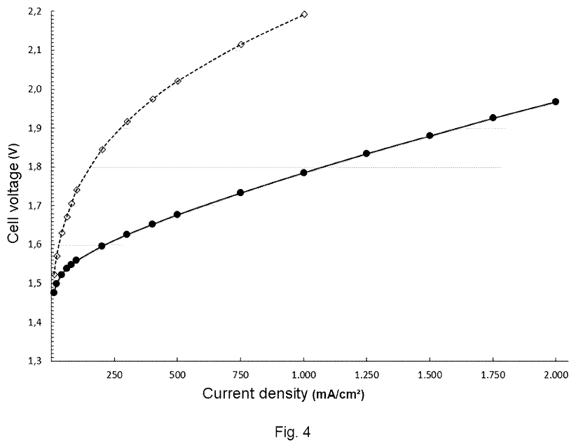

The catalytically coated membranes from examples 9 and 10 were tested in an electrolysis cell with an active area of 25 cm². The catalyst layer served as a cathode catalyst. On the anode side, a dimensionally stable, porous stainless steel electrode was used. During the electrolysis experiments, the measurement cell was heated to 60° C. and flushed with 1 M KOH solution on the anode and cathode sides. The characteristic current-voltage lines are shown in FIG. 4. The associated key may be found in table 3.

### FIG. 4: Characteristic Current/Voltage Lines

TABLE 3
Key to FIG. 4

| Membrane | Qualification | Label | Curve |
|---|---|---|---|
| 9 | noninventive | empty rhombi | dashed |
| 10 | inventive | filled circles | solid |

In the graphs, the voltage required has been plotted against the externally applied current intensity. At a constant current intensity (e.g. 1000 mA/cm²) a low voltage is preferable since this reduces the required electrical energy for production of the same amount of hydrogen at an identical production rate, thus increasing efficiency. Current intensities particularly relevant for industrial application are those exceeding 500 mA/cm². It is apparent that at the higher current densities of the CCM produced according to the invention the characteristic current-voltage line is lower than that of the (noninventive) CCM produced for reference. The lower current density results in lower power consumption at the same voltage, and so the specific energy demand of the CCM produced according to the invention is lower.

### 14. Conclusion

It is apparent from the comparison of the characteristic current-voltage lines in FIG. 4 that the CCM produced according to the invention with antiswelling agent-containing composition achieves a higher efficiency in an alkaline water electrolysis than the CCM coated with conventional, antiswelling agent-free composition. The higher efficiency can be attributed to the fact that the coating was effected more homogeneously and that a somewhat thicker catalyst layer was able to be applied as a result of the elevated viscosity.

### Appendix

TABLE 1
Hansen parameters of various substances at 20° C. in
MPa^{0.5}, their CMR classification* and suitability as antiswelling agents

| | | | | | As antiswelling |
|---|---|---|---|---|---|
| Substance | CMR* | δD | δP | δH | agent |
| cycloheptanone | no | 17.2 | 10.6 | 4.8 | suitable |
| cyclohexanone | no | 17.8 | 8.4 | 5.1 | suitable |
| (1S,5R)-6,8- | no | 18.8 | 10.6 | 6.9 | suitable |
| dioxabicyclo | | | | | |
| [3.2.1] | | | | | |
| octan-4-one | | | | | |
| cyclopentanone | no | 17.9 | 11.9 | 5.2 | suitable |
| propylene carbonate | no | 20.0 | 18.0 | 4.1 | unsuitable |
| acetonitrile | no | 15.3 | 18.0 | 6.1 | unsuitable |
| benzonitrile | no | 18.8 | 12.0 | 3.3 | suitable |
| dimethyl sulfoxide | no | 18.4 | 16.4 | 10.2 | unsuitable |
| polyethylene | no | 17.9 | 4.0 | 13.9 | unsuitable |
| glycol 400 | | | | | |
| water | no | 15.5 | 16.0 | 42.3 | unsuitable |
| ethanol | no | 15.8 | 8.8 | 19.4 | unsuitable |
| N-methyl-2-pyrrolidone | yes | 18.0 | 12.3 | 7.2 | unsuitable |
| 1-propanol | no | 16.0 | 6.8 | 17.4 | unsuitable |
| 2-propanol | no | 15.8 | 6.1 | 16.4 | unsuitable |
| methanol | yes | 14.7 | 12.3 | 22.3 | unsuitable |
| butanone | no | 16.0 | 9.0 | 5.1 | suitable |
| acetone | no | 15.5 | 10.4 | 7.0 | suitable |
| 1-butanol | no | 16.0 | 5.7 | 15.8 | unsuitable |
| glycerol | no | 17.4 | 11.3 | 27.2 | unsuitable |
| propane-1,2-diol | no | 16.8 | 10.4 | 21.3 | unsuitable |
| ethylene glycol | yes | 17.0 | 11.0 | 26.0 | unsuitable |
| 1,4-dioxane | yes | 17.5 | 1.8 | 9.8 | unsuitable |
| furfuryl alcohol | yes | 17.4 | 7.6 | 15.1 | unsuitable |
| N,N-dimethylformamide | yes | 17.4 | 13.7 | 11.3 | unsuitable |
| dimethylacetamide | yes | 16.8 | 11.5 | 9.4 | unsuitable |
| acetophenone | no | 18.8 | 9.0 | 4.0 | suitable |

CMR classification according to GH808. The CMR classification data are solely for the purposes of the present application. Substances whose CMR status is shown as “no” are not necessarily safe. These data especially cannot be used to justify actions or omissions relevant under the law governing hazardous substances.

1. Process for producing a coated anion exchange membrane comprising the following non-chronological steps
a) providing a viscous composition containing at least the following components:
i) an electrocatalyst;
ii) a solvent;
iii) an anion-conducting polymer;
b) providing an anion exchange membrane containing at least one membrane material;
c) applying the viscous composition to the anion exchange membrane;
d) drying the viscous composition applied to the anion exchange membrane;
e) obtaining a coated anion exchange membrane which comprises at least on one side a layer comprising the electrocatalyst and the anion-conducting polymer, wherein the electrocatalyst is joined to the membrane material via the anion-conducting polymer;
wherein the anion-conducting polymer, the membrane material and the solvent are selected to be matched to one another such that the anion-conducting polymer and the membrane material are each soluble in the solvent;
characterized
in that the viscous composition additionally contains the following component:
iv) an organic substance distinct from the solvent;
wherein the solubility parameters δD, δP and δH of the organic substance determined according to Hansen are in the following ranges:
$$15 {MPa}^{0.5} < δ D < 35 {MPa}^{0.5}$$
$$6 {MPa}^{0.5} < δ P < 15 {MPa}^{0.5}$$
$$2.5 {MPa}^{0.5} < δ H < 7.1 {MPa}^{0.5}$$

2. Process according to claim 1, wherein the organic substance is selected from the group consisting of the following substances: (1S,5R)-6,8-dioxabicyclo[3.2.1]octan-4-one, cyclopentanone, cyclohexanone, cycloheptanone, benzonitrile, acetone, butanone, acetophenone.

3. Process according to claim 1, characterized in that the solvent is selected from the group consisting of the following substances: dimethyl sulfoxide, ethanol, methanol, 1-propanol, 2-propanol, acetonitrile.

4. Process according to claim 3, characterized in that the solvent is a solvent mixture containing two or more substances selected from the recited group.

5. Process according to claim 1, characterized in that the anion-conducting polymer is completely dissolved in the solvent or the solvent mixture.

6. Process according to claim 1, characterized in that the electrocatalyst is in particulate form and contains at least one element selected from the group consisting of the following elements: iridium (Ir), nickel (Ni), cobalt (Co), chromium (Cr), iron (Fe), ruthenium (Ru), copper (Cu), molybdenum (Mo), zinc (Zn), lead (Pb), manganese (Mn), tungsten (W), platinum (Pt), sulfur(S), tin (Sn), gold (Au), silver (Ag), palladium (Pd), rhenium (Re), rhodium (Rh), cerium (Ce), wherein the element is present in its pure form or as oxide or as hydroxide or as oxide hydroxide or as phosphide.

7. (canceled)

8. Process according to claim 1, characterized in that the viscous composition additionally comprises the following component:
v) a dispersing medium;
wherein the dispersing medium is identical neither to the solvent or the solvent mixture nor to the organic substance.

9. Process according to claim 8, characterized in that the dispersing medium is water.

10. Process according to any of claim 1, characterized in that the weight fractions of the components, in each case based on the total weight of the viscous composition, are in the following ranges with the proviso that the sum of the weight fractions of all components listed here does not exceed 100% by weight:

| | Minimum | Maximum |
|---|---|---|
| | content (% | content (% |
| Component | by wt.) | by wt.) |
| Electrocatalyst | 1 | 30 |
| solvent | 10 | 40 |
| organic substance | 45 | 90 |
| Anion-conducting polymer | 0.1 | 10 |
| Dispersing medium | 0 | 20 |

11. Process according to claim 1 additionally containing at least one additive, wherein the additive is selected from the group consisting of the following additives: rheology aid, conductivity additive.

12. (canceled)

13. Process according to claim 1, wherein the viscous composition has a dynamic viscosity η, for which a characteristic value is determined according to the method defined in the description, characterized in that the characteristic value of the dynamic viscosity η is between 10 mPas and 10⁴ mPas.

14. Process according to claim 1, characterized in that the anion-conducting polymer contains at least one structure conforming to any of formulae (I), (II), (III): 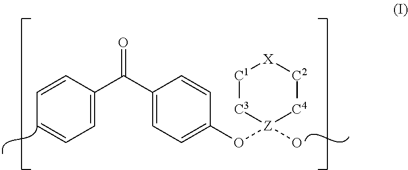
wherein, in (I), X is a structural element comprising a positively charged nitrogen atom which is bonded to C¹ and C² and which is bonded via two bonds to one or two hydrocarbon radicals, comprising 1 to 12, preferably 1 to 6, particularly preferably 1 or 5, carbon atoms
and wherein, in (I), Z is a structural element comprising a carbon atom which is bonded to C³ and C⁴ and which comprises at least one aromatic six-membered ring bonded directly to one of the oxygen atoms, wherein the aromatic six-membered rings may be substituted with one or more halogen radicals and/or one or more C₁- to C₄-alkyl radicals; 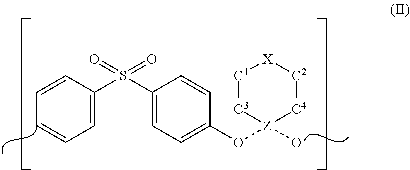
wherein, in (II), X is a structural element comprising a positively charged nitrogen atom which is bonded to C¹ and C² and which is bonded via two bonds to one or two hydrocarbon radicals, comprising 1 to 12, preferably 1 to 6, more preferably 1 or 5, carbon atoms,
and wherein, in (II), Z is a structural element comprising a carbon atom which is bonded to C³ and C⁴ and which comprises at least one aromatic six-membered ring bonded directly to one of the oxygen atoms, where the aromatic six-membered ring may be substituted in positions 3 and 5 with the same or different C₁- to C₄-alkyl radicals, in particular with a methyl, isopropyl or tert-butyl group, preferably a methyl group; 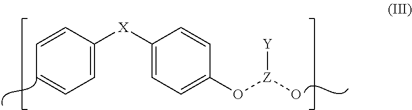
wherein, in (III), X is a ketone or sulfone group;
wherein, in (III), Z is a structural element comprising at least one tertiary carbon atom and at least one aromatic six-membered ring, wherein the aromatic six-membered ring is bonded directly to one of the two oxygen atoms;
and wherein, in (III), Y is a structural element comprising at least one positively charged nitrogen atom, wherein this nitrogen atom is bonded to the structural element Z.

15. Process according to claim 1, characterized in that the membrane material and the anion-conducting polymer have the same repeating unit or are identical.

16. Process according to claim 1, characterized in that neither the solvent or the solvent mixture nor the organic substance are carcinogenic or mutagenic or reprotoxic.

17. Process according to claim 1, wherein the step of
c) applying the viscous composition to the anion exchange membrane;
is effected by applying the viscous composition directly to the anion exchange membrane, namely without the use of a transfer substrate.

18. Process according to claim 1, wherein the anion-conducting polymer, the membrane material and the organic substance are selected to be matched to one another such that the anion-conducting polymer and the membrane material are each insoluble in the organic substance.

19. Coated anion exchange membrane containing a membrane material and at least one layer comprising an electrocatalyst and an anion-conducting polymer, wherein the electrocatalyst is joined to the membrane material via the anion-conducting polymer, characterized in that that the coated anion exchange membrane contains traces of a substance selected from the group consisting of the following substances: (1S,5R)-6,8-dioxabicyclo[3.2.1]octan-4-one, cyclopentanone, cyclohexanone, cycloheptanone, benzonitrile, acetone, butanone, acetophenone.

20. Coated anion exchange membrane according to claim 19, wherein the weight fraction of the traces based on the total weight of the coated anion exchange membrane is between 0% by weight and 10% by weight.

21. Coated anion exchange membrane according to claim 19 obtainable by a process according to claim 2.

22. Production of hydrogen and oxygen by alkaline water electrolysis, characterized by the presence of a coated anion exchange membrane according to claim 19.
